(19) United States
(12) Patent Application Publication
(10) Pub. No.: US 2009/0287888 A1
(43) Pub. Date: Nov. 19, 2009

(54) SEMICONDUCTOR MEMORY DEVICE AND DATA INPUT/OUTPUT METHOD THEREOF

(75) Inventor: Tatsuya ISHIZAKI, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/436,483

(22) Filed: May 6, 2009

(30) Foreign Application Priority Data
May 19, 2008 (JP) 2008-130603
Oct. 6, 2008 (JP) 2008-259459

(51) Int. Cl. G06F 12/00; G06F 12/02

(52) U.S. Cl. 711/154; 711/202; 711/E12.001

(57) ABSTRACT

To solve a problem in that it is difficult for a conventional semiconductor memory device to improve a data transfer rate, there is provided a semiconductor memory device including: a first sub-array (data sub-array) that holds write data input from an outside of the semiconductor memory device; an input data recognition circuit (21) that generates decision bit information associated with the write data based on a combination of data items contained in the write data; a second sub-array (decision sub-array) that holds the decision bit information; an internal address generation circuit (24) that generates an internal address for selectively specifying read data stored in the first sub-array, based on the decision bit information; and an output circuit (25) that outputs the read data selected by the internal address.

### BACKGROUND

1. Field of the Invention

The present invention relates to a semiconductor memory device and a data input/output method thereof. In particular, the present invention relates to a semiconductor memory device that reads out data in a burst operation, and a data input/output method thereof.

2. Description of Related Art

In recent years, with the development of information processing technology, there is a demand for higher data processing speed. In the field of information processing technology, data defining a multi-dimensional space can be used for matrix computation, image processing, and the like. In the image processing, for example, with the recent tendency toward high-definition display devices, there is a demand for displaying more pixels at a higher speed. In view of this, a method has been proposed in which a memory device having memory cells arranged in a lattice form is used to reproduce a multi-dimensional space in the memory device, and an address in a data space is associated with an address in the memory device, to thereby achieve high-speed data processing. An example of such a data processing method is disclosed in Japanese Unexamined Patent Application Publication No. 10-112179.

FIG. 9 shows a block diagram of a semiconductor memory device disclosed in Japanese Unexamined Patent Application Publication No. 10-112179. In this example, the semiconductor memory device includes a plurality of sub-arrays 106-0 to 106-7, and stores data items of different rows of rectangular data in different sub-arrays. Then, data write processing and data read processing are performed in parallel, thereby achieving high-speed processing.

Further, Japanese Unexamined Patent Application Publication No. 2006-209651 discloses a technique of transmitting and receiving data between a graphics engine and a memory in a burst operation for sequentially transferring a plurality of data items in response to a single write instruction or a single read instruction. Thus, the technique disclosed in Japanese Unexamined Patent Application Publication No. 2006-209651 results in an increase in image data transfer rate.

### SUMMARY

In the case of using a three-dimensional image, however, in order to accurately define a pixel coordinate of the three-dimensional image, not only image data used for display but also data which is not used for display is stored in a memory. In this regard, the present inventor has found the following problem. That is, in the case of using three-dimensional image data, an amount of data greater than an amount of data originally used for display needs to be transferred between a graphics engine (or arithmetic circuit) and a memory, even when the techniques disclosed in Japanese Unexamined Patent Application Publication Nos. 10-112179 and 2006-209651 are used, which hinders a high-speed system operation.

A first exemplary aspect of an embodiment of the present invention is a semiconductor memory device including: a first sub-array that holds write data input from an outside of the semiconductor memory device; an input data recognition circuit that generates decision bit information associated with the write data, based on a combination of data items contained in the write data; a second sub-array that holds the decision bit information; an internal address generation circuit that generates an internal address for selectively specifying read data stored in the first sub-array, based on the decision bit information; and an output circuit that outputs the read data selected by the internal address.

A second exemplary aspect of an embodiment of the present invention is a semiconductor memory device including: a sub-array that holds write data input from an outside of the semiconductor memory device; an output data recognition circuit that generates decision bit information associated with read data, based on a combination of data items contained in the read data stored in the sub-array; an internal address generation circuit that generates an internal address for selectively specifying the read data, based on the decision bit information; and an output circuit that holds the read data and outputs the read data selected by the internal address.

A third exemplary aspect of an embodiment of the present invention is a semiconductor memory device including: a first sub-array that holds data input from an outside of the semiconductor memory device; a data recognition circuit that generates decision bit information corresponding to the data, based on a combination of values contained in the data; an internal address generation circuit that generates an internal address for selectively specifying the data stored in the first sub-array, based on the decision bit information; and an output circuit that outputs the data selected by the internal address.

A fourth exemplary aspect of an embodiment of the present invention is a data input/output method of a semiconductor memory device, including: holding write data input from an outside of the semiconductor memory device; generating decision bit information based on a combination of data items contained in the write data; generating an internal address for selectively specifying read data, based on the decision bit information; and outputting the read data selected by the internal address.

A fifth exemplary aspect of an embodiment of the present invention is a data input/output method of a semiconductor memory device, including: holding write data input from an outside of the semiconductor memory device; generating decision bit information based on a combination of data items contained in the write data output as read data; generating an internal address for selectively specifying the read data, based on the decision bit information; and outputting the read data selected by the internal address.

A sixth exemplary aspect of an embodiment of the present invention is a data input/output method of a semiconductor memory device, including: holding data input from an outside of the semiconductor memory device; generating decision bit information based on a combination of values contained in the data; generating an internal address for selectively specifying the data based on the decision bit information; and outputting the data selected by the internal address.

In the semiconductor memory device and the data input/output method thereof according to an exemplary embodiment of the present invention, the internal address for selectively specifying the read data to be output, by using the decision bit information generated based on the write data input from the outside or based on the read data output from the sub-array. Then, only the read data specified by the internal address is output. Therefore, in the semiconductor memory device and the data input/output method thereof according to an exemplary embodiment of the present invention, the decision bit information is used as information indicating that only the read data to be used is selected in advance, thereby making it possible to selectively transfer the necessary data.

According to the semiconductor memory device and the data input/output method thereof of an exemplary embodiment of the present invention, it is possible to reduce the time for transferring data.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a display system according to a first exemplary embodiment of the present invention;

FIG. 2 is a block diagram showing a memory according to the first exemplary embodiment;

FIG. 3 is a schematic view showing write data items input to the memory according to the first exemplary embodiment and an arrangement of the write data items in the memory;

FIG. 4 is a table showing a relationship between read data and decision bit information in the memory according to the first exemplary embodiment;

FIG. 5 is a schematic view showing an arrangement of the write data items in the memory according to the first exemplary embodiment and read data items;

FIG. 6 is a timing diagram showing a read operation of the memory according to the first exemplary embodiment;

FIG. 7 is a timing diagram showing a read operation of a memory according to a related art;

FIG. 8 is a block diagram showing a memory according to a second exemplary embodiment of the present invention; and

FIG. 9 is a block diagram showing a memory disclosed in Japanese Unexamined Patent Application Publication No. 10-112179.

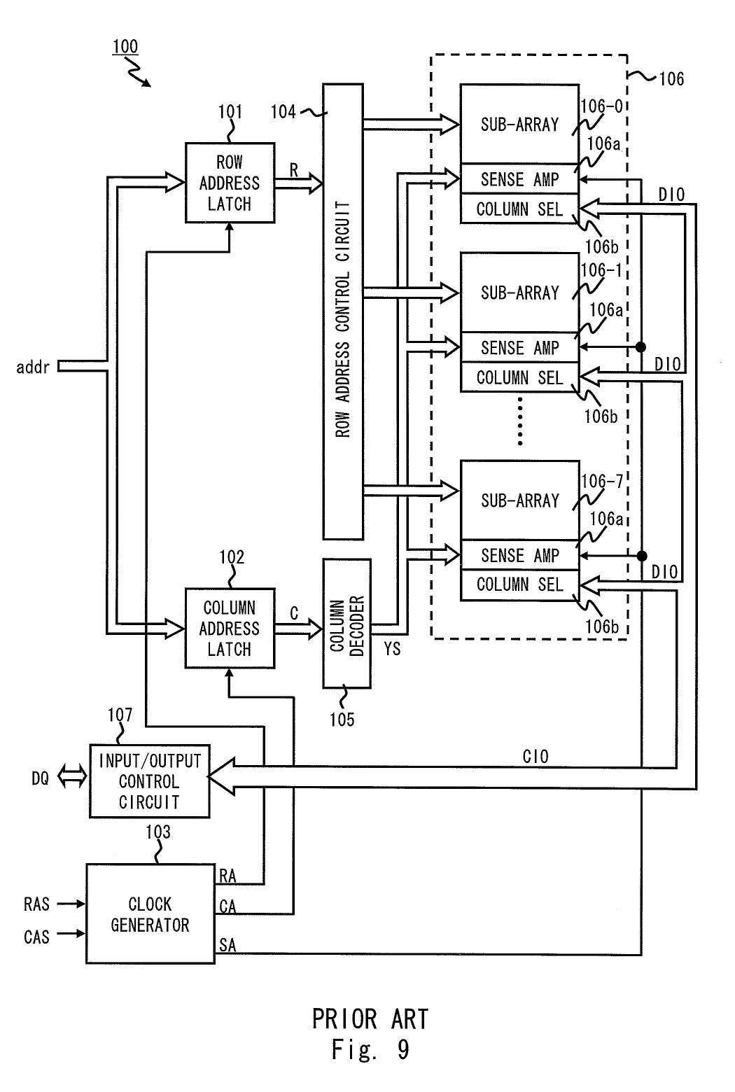

### DETAILED DESCRIPTION OF THE EXEMPLARY EMBODIMENTS

### First Exemplary Embodiment

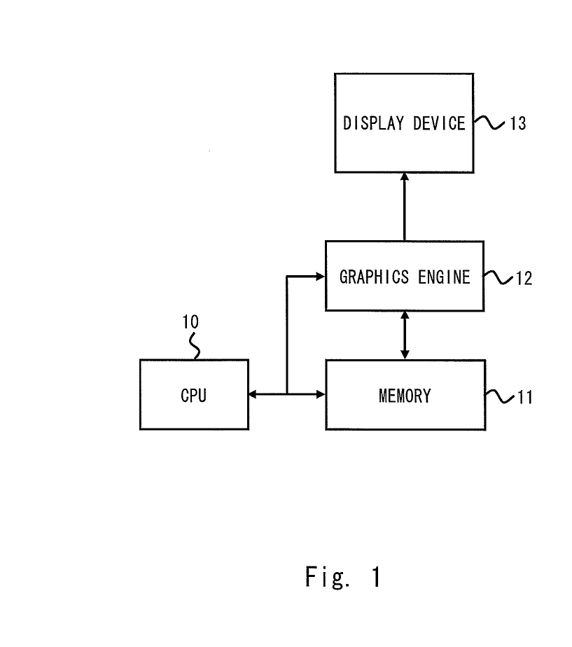

Hereinafter, exemplary embodiments of the present invention will be described with reference to the accompanying drawings. FIG. 1 shows a block diagram of a display system incorporating a semiconductor memory device (hereinafter, referred to as “memory”) according to an exemplary embodiment of the present invention. As shown in FIG. 1, the display system includes an arithmetic circuit (for example, central processing unit (CPU)) 10, a memory 11, a graphics engine 12, and a display device 13.

The CPU 10 reads out a program from a memory device (not shown) to perform various processings according to the read program. Then, the CPU 10 provides a display instruction for displaying an image to the graphics engine 12, as one of the various processings. Further, the CPU 10 uses the memory 11 as a temporary storage device in the various processings.

The memory 11 stores data for use in processings performed by the CPU 10 and the graphics engine 12. In this case, the memory 11 according to an exemplary embodiment of the present invention performs characteristic processing when the memory 11 is used by the graphics engine 12. The characteristic processing of the memory 11 is described in detail later. The graphics engine 12 performs display processing for displaying an image on the display device 13 in accordance to the display instruction from the CPU 10. The display device 13 is a monitor used for a computer or a consumer electronic device. An image rendered by the graphics engine 12 is displayed on the display device 13.

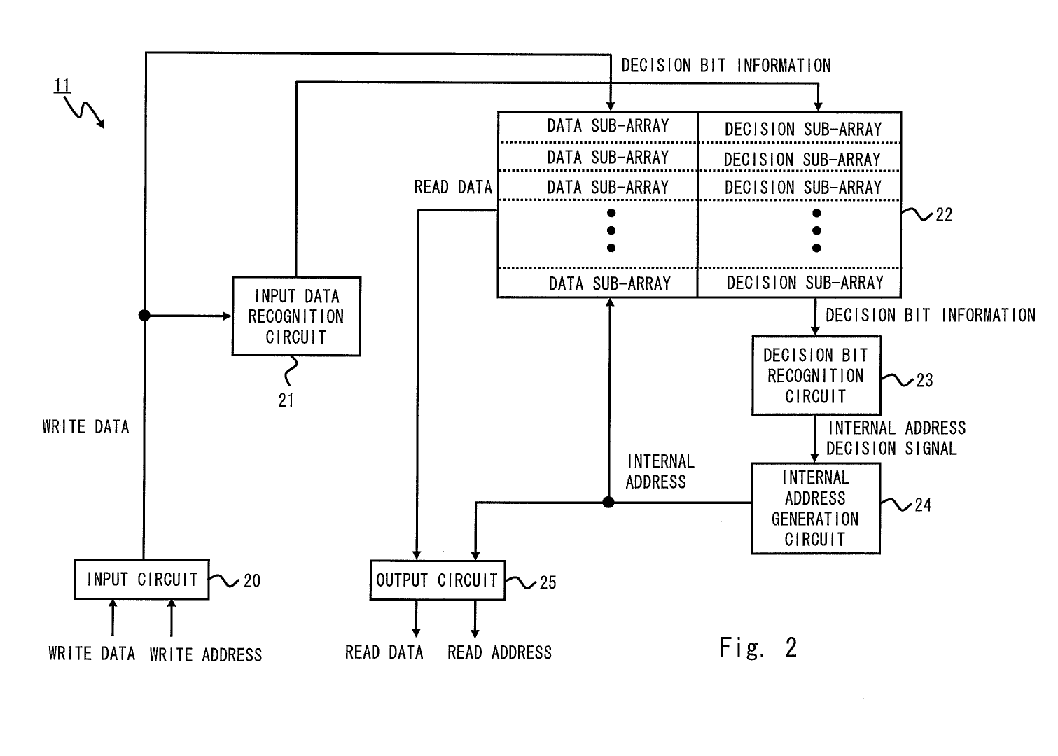

The memory 11 is herein described in detail. FIG. 2 shows a block diagram of the memory 11. As shown in FIG. 2, the memory 11 includes an input circuit 20, an input data recognition circuit 21, a memory array 22, a decision bit recognition circuit 23, an internal address generation circuit 24, and an output circuit 25.

The input circuit 20 receives write data and a write address which are transmitted from the CPU 10 or the graphics engine 12, and transmits the write data and the write address to each block in the memory 11. In this case, the write data is transmitted to the input data recognition circuit 21 and data sub-arrays provided in the memory array 22. Further, the write address is transmitted to an array control circuit (not shown) that controls the memory array 22.

The input data recognition circuit 21 generates decision bit information based on a combination of data items contained in the input data. More specifically, when the combination of data items contained in the write data is a predetermined characteristic value, the input data recognition circuit 21 sets the decision bit information as a first logical value (for example, “0”), and when the combination of data items contained in the write data includes a value other than the predetermined characteristic value, the input data recognition circuit 21 sets the decision bit information as a second logical value (for example, “1”). In this case, the term “predetermined characteristic value” refers to a combination of data items determined depending on the system incorporating the memory 11. It is assumed herein that the predetermined characteristic value according to an exemplary embodiment of the present invention refers to a combination in which all the values of the data items contained in the write data are “0”. Note that the predetermined characteristic value is a preset value.

The memory array 22 includes a plurality of sub-arrays that are independently controlled. According to an exemplary embodiment of the present invention, among the plurality of sub-arrays, sub-arrays storing data input from an outside of the memory are each referred to as a data sub-array, and sub-arrays storing the decision bit information are each referred to as a decision sub-array.

The decision bit recognition circuit 23 reads out the decision bit information from the decision sub-arrays, and outputs an internal address decision signal for specifying a data item to be read among the write data items stored in the data sub-arrays. The internal address decision signal is output to the internal address generation circuit 24.

The internal address generation circuit 24 generates an internal address for specifying a position of the read data, which is to be read, on the memory array 22 according to the internal address decision signal. That is, the internal address is used to selectively specify the read data to be read among the data items stored in the data sub-arrays. The internal address is input to the array control circuit (not shown) that controls the memory array 22, and the array control circuit selects the stored data based on the internal address and outputs the selected data as the read data.

The output circuit 25 receives the read data output from the memory array 22 and the internal address, and outputs the read data and the internal address to the outside of the memory 11. At this time, the output circuit 25 associates the read data with the internal address corresponding to the read data, and outputs the read data associated with the internal address.

Next, a data input method of the memory 11 is described in detail. In the following description, it is assumed that the memory 11 includes eight data input/output terminals (I/O0 to I/O7), and transmits/receives data to/from the CPU 10 or the graphics engine 12 in a burst operation. Note that the term “burst operation” refers to an operation for sequentially transferring a plurality of data items in response to a single write instruction or a single read instruction. Further, timings of transferring data in the burst operation are indicated by bursts 0 to 3 (when a burst length is 4). Furthermore, it is hereinafter assumed that the decision bit information is composed of four bits. The bit length of the decision bit information is determined depending on the burst length and is not limited to four bits.

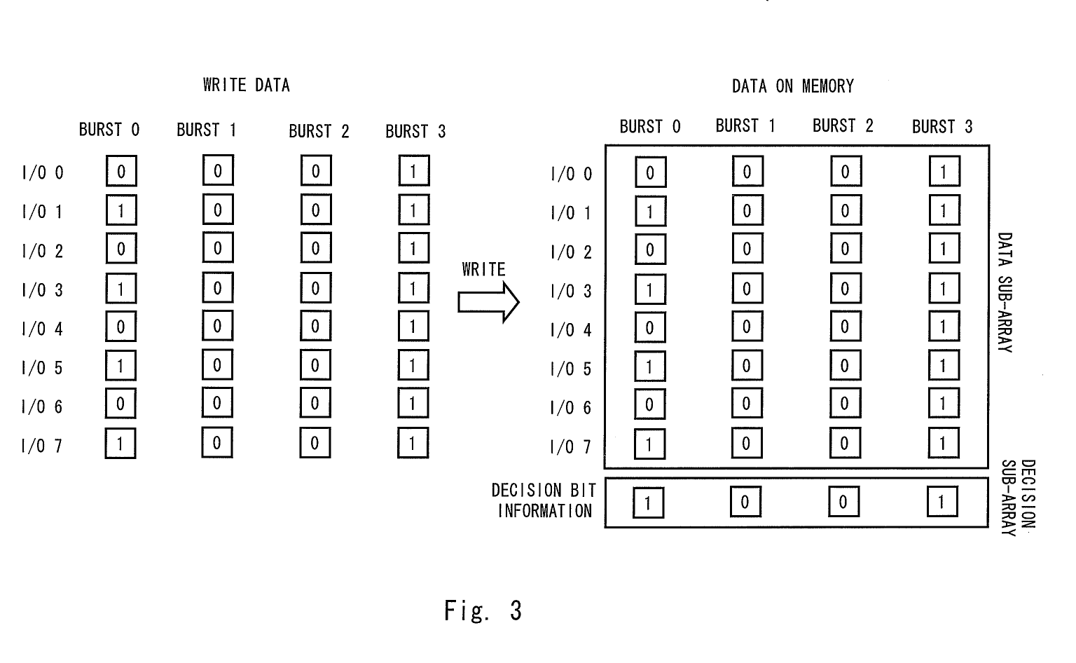

FIG. 3 shows write data items input to the memory 11 and a state where the write data items are stored in the memory 11. As shown in FIG. 3, the write data items are sequentially input to the memory 11 at each timing of burst 0 to burst 3. In this case, the write data items are input in parallel to the input/output terminals I/O0 to I/O7 at each burst operation timing. Then, the write data items are stored in the data sub-arrays of the memory 11 at each burst operation timing.

Further, the input data recognition circuit 21 generates the decision bit information in the memory 11. The decision bit information is generated at each burst operation timing. For example, when the write data input at the timing of burst 0 contains data items having a value other than “0”, the input data recognition circuit 21 generates decision bit information indicating “1” (second logical value) with respect to the write data input at the timing of burst 0. Meanwhile, when all the write data items input at the timing of burst 1 are “0”, which is the predetermined characteristic value, the input data recognition circuit 21 generates decision bit information indicating “0” (first logical value) with respect to the write data input at the timing of burst 1. Through a similar operation, the input data recognition circuit 21 generates the decision bit information indicating “0” with respect to the write data input at the timing of burst 2, and generates the decision bit information indicating “1” with respect to the write data input at the timing of burst 3. The decision bit information is stored in each decision sub-array at each burst operation timing.

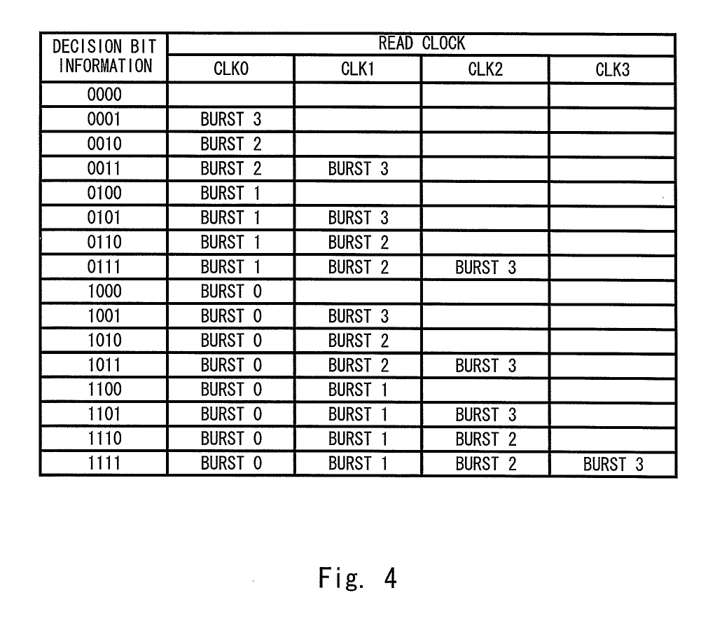

Next, a data output method of the memory 11 is described. The memory 11 outputs data at each timing of the burst operation performed when the data is input. In this case, the memory 11 selects data to be output, which is input at any of the burst operation timings, by using the decision bit information, and outputs only the selected read data in the burst operation. In this regard, FIG. 4 shows a table illustrating a relationship between the decision bit information and the selected read data. Note that, in an example shown in FIG. 4, the timings of outputting data are indicated by read clocks CLK0 to CLK3.

Referring to FIG. 4, in the memory 11, the number of read data items to be output is determined based on the value “1” (first logical value) indicated by the bit information, and the position of the read data to be selected is determined based on the location at which the decision bit information indicates “1” (first logical value). For example, when the decision bit information indicates “0001”, only the data input at the timing of burst 3 is output as the read data in synchronization with the read clock CLK0. Further, when the decision bit information indicates “1001”, the data input at the timing of burst 0 is output in synchronization with the read clock CLK0, and the data input at the timing of burst 3 is output in synchronization with the read clock CLK1.

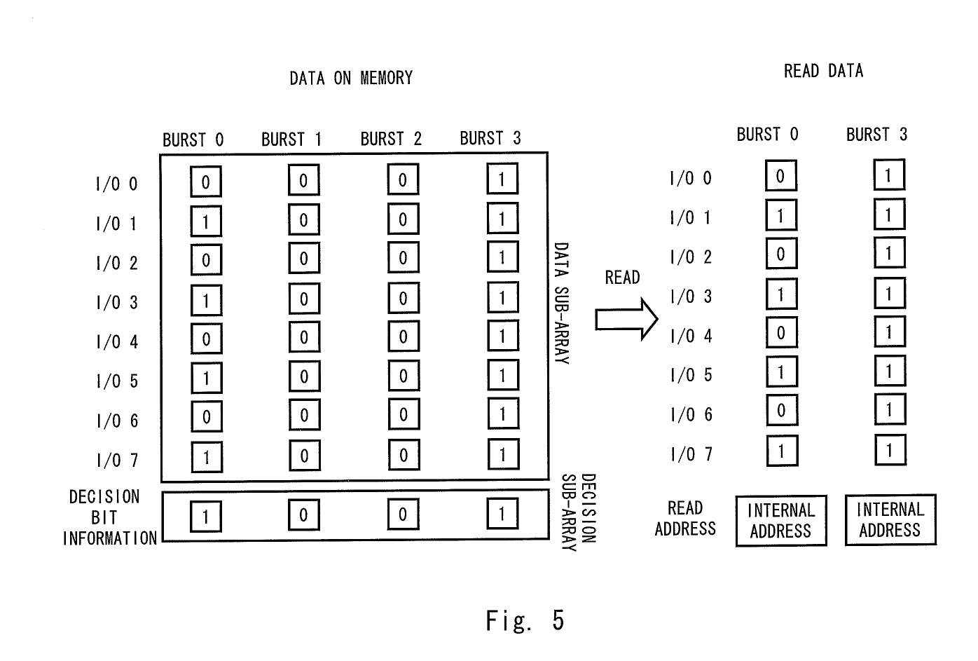

FIG. 5 is a schematic diagram showing an example of the read operation. FIG. 5 shows read data items stored in the memory 11 and a state where the read data items are output when the decision bit information indicates “1001”. As shown in FIG. 5, the memory 11 outputs only the read data obtained when the decision bit information indicates “1” from the input/output terminals I/O0 to I/O7 at successive burst operation timings. Further, the internal address corresponding to the read data is output as a read address together with the read data at each burst operation timing.

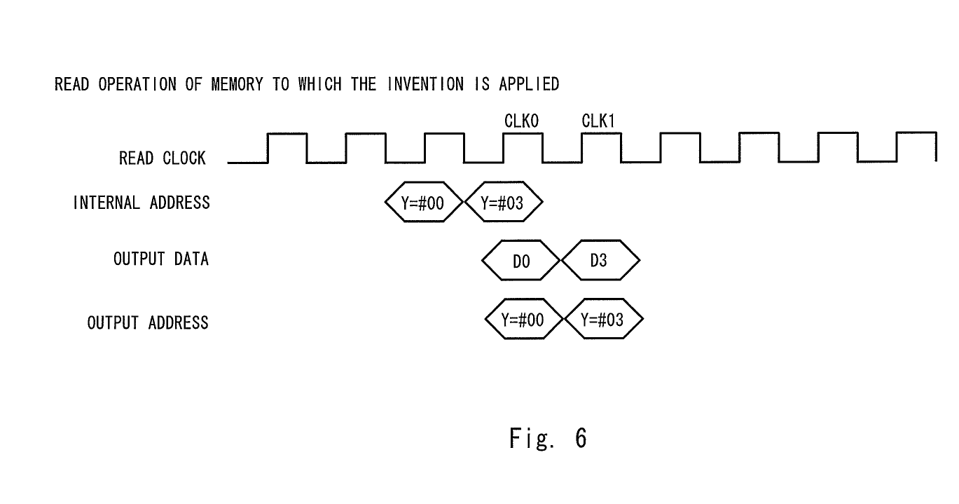

FIG. 6 shows a timing diagram illustrating a read operation of the memory 11. As shown in FIG. 6, prior to output of data D0 (data obtained at the timing of burst 0) which is first transferred in the burst operation, the memory 11 generates an internal address Y=#00 for specifying the data D0. After that, the data D0 and the internal address Y=#00 are output in synchronization with the read clock CLK0. Further, prior to output of data D1 (data obtained at the timing of burst 3) which is subsequently transferred, the memory 11 generates an internal address Y=#03 for specifying the data D1. After that, the data D1 and the internal address Y=#03 are output in synchronization with the read clock CLK1 subsequent to the read clock CLK0.

As described above, the memory 11 according to an exemplary embodiment of the present invention is capable of generating the decision bit information based on a combination of data items contained in the input read data, to selectively specify the read data to be output in the memory based on the decision bit information. Accordingly, if the data to be stored in the memory 11 contains data unnecessary for essential processing, data obtained by thinning out unnecessary data can be output in the burst operation. This results in a reduction in time for the memory 11 to transfer data.

When three-dimensional image data is used as the write data, for example, all the data items that are not used for display in the three-dimensional image data may be “0”. In this case, when the memory 11 according to an exemplary embodiment of the present invention is used, only the data to be displayed can be transferred rapidly in the burst operation without transferring the data which is not used for display (for example, a group of data items each indicating “0”). Therefore, the memory 11 according to an exemplary embodiment of the present invention exerts an advantageous effect particularly when the memory stores the data containing the data which is not used for the actual processing, such as three-dimensional image data.

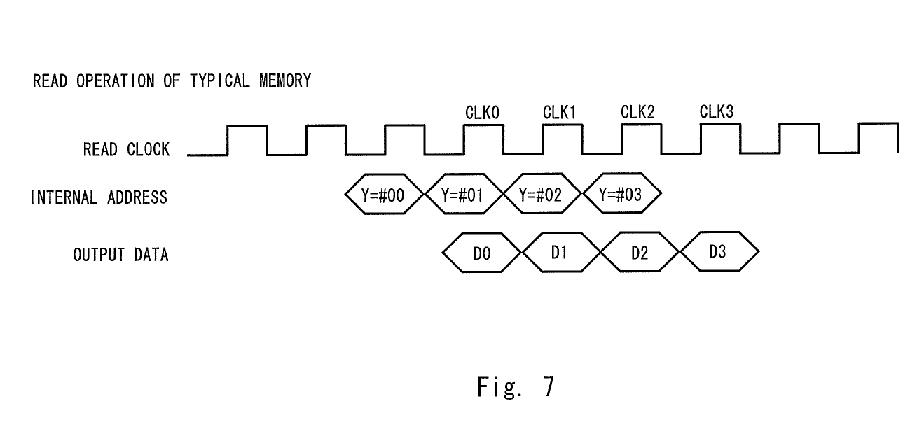

Here, FIG. 7 shows a timing diagram of a read operation of a memory according to the related art to compare the memory 11 according to an exemplary embodiment of the present invention with the memory according to the related art. An example shown in FIG. 7 corresponds to the operation of the memory 11 shown in FIG. 6. As shown in FIG. 7, the memory according to the related art transfers data without thinning out the data. Accordingly, even when all the read data items corresponding to burst 1 and burst 2 (data D1 and data D2 of FIG. 7) are “0”, four read clocks are required to read out the necessary read data (at the timing of burst 0 (data D0 of FIG. 7) and at the timing of burst 3 (data D3 of FIG. 7)). This example shows that it takes twice as long for the memory according to the related art to transfer the same amount of data as that of the memory 11 according to an exemplary embodiment of the present invention.

Further, the memory 11 according to an exemplary embodiment of the present invention outputs the internal address as the read address together with the read data. As a result, for example, the graphics engine 12 can be notified of information indicating that the data has not been transferred. Upon receiving the notification, the graphics engine 12 can be notified of information indicating whether the data transfer has been completed or not, based on the notified internal address. Then, upon receiving the notification (for example, internal address information), the graphics engine 12 can supplement non-received data, thereby restoring the original data. In this case, only the write data indicating the preset predetermined characteristic value is intended for the read data thinned out in the memory 11 according to an exemplary embodiment of the present invention. Accordingly, the graphics engine 12 can be easily notified of which data has not been transferred.

Further, according to an exemplary embodiment of the present invention, the write data (or read data) and the decision bit information are stored in different sub-arrays. Since the different sub-arrays are independently controllable, the memory 11 can prepare in advance the internal address for specifying the read data based on the decision bit information stored in the decision sub-array, before starting the read operation. In this case, in the memory 11, the decision bit recognition circuit 23 reads out the decision bit information and outputs the internal address decision signal to the internal address generation circuit 24. Then, the internal address generation circuit 24 generates the internal address without a delay during the read operation. The above-mentioned processing prevents the operation of the memory 11 from being delayed.

### Second Exemplary Embodiment

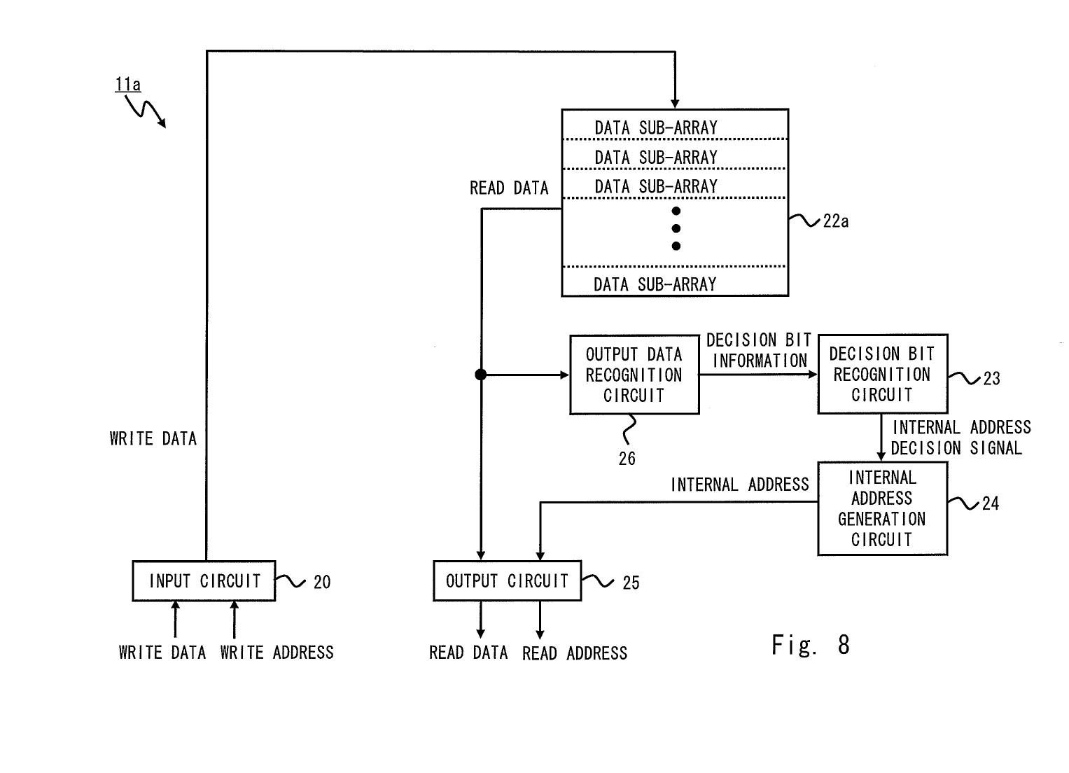

According to a second exemplary embodiment of the present invention, a modified example of the memory 11 is described. FIG. 8 shows a block diagram of a memory 11a as a modified example of the memory 11. As shown in FIG. 8, the memory 11a includes the input circuit 20, a memory array 22a, the decision bit recognition circuit 23, the internal address generation circuit 24, the output circuit 25, and an output data recognition circuit 26. In short, the memory 11a includes the output data recognition circuit 26 in place of the input data recognition circuit 21 of the memory 11 according to the first exemplary embodiment. Additionally, the structure of the memory array is modified upon change of the data recognition circuit. The memory array having a modified structure is referred to as the memory array 22a. Note that an operation of a display system incorporating the memory 11a according to the second exemplary embodiment is similar to that of the first exemplary embodiment, so a description thereof is omitted. Further, components of the memory 11a according to the second exemplary embodiment which are identical with those of the memory 11 according to the first exemplary embodiment are denoted by the same reference symbols of the memory 11 shown in FIG. 2, and a description thereof is omitted.

The memory array 22a is different from the memory array 22 of the memory 11 in that the decision sub-arrays are omitted. The data sub-arrays of the memory array 22a store write data input through the input circuit 20. The write data stored in the data sub-arrays of the memory array 22a is output as read data.

The output data recognition circuit 26 generates decision bit information based on a combination of data items contained in the read data output from the memory array 22a. More specifically, when the combination of data items contained in the read data is the predetermined characteristic value, the output data recognition circuit 26 sets the decision bit information as the first logical value (for example, “0”), and when the combination of data items contained in the read data is a value other than the predetermined characteristic value, the output data recognition circuit 26 sets the decision bit information as the second logical value (for example, “1”). In this case, the term “predetermined characteristic value” refers to a combination of data items determined depending on the system incorporating the memory. It is assumed herein that the predetermined characteristic value according to an exemplary embodiment of the present invention refers to a combination in which all the values of the data items contained in the write data are “0”. Note that the predetermined characteristic value is a preset value and can be arbitrarily set. More specifically, in the memory 11a, the decision bit recognition circuit 23 receives the decision bit information not from the decision sub-arrays of the memory array but from the output data recognition circuit 26.

As described above, the memory 11a according to the second exemplary embodiment is different from the memory 11 according to the first exemplary embodiment in the timing of generating the decision bit information and in the way of providing the decision bit information to the decision bit recognition circuit 23. Also the memory 11a is capable of outputting the read data in the burst operation while thinning out unnecessary data by using the decision bit information in the same manner as the memory 11 according to the first exemplary embodiment. In other words, the use of the memory 11a according to the second exemplary embodiment results in a reduction in time for transferring data, as in the case of the memory 11 according to the first exemplary embodiment.

Furthermore, the memory 11a according to the second exemplary embodiment eliminates the need of providing the decision sub-arrays to the memory array. Therefore, the use of the memory 11a according to the second exemplary embodiment results in a reduction in circuit area of the memory array, as compared with the memory 11 according to the first exemplary embodiment.

Note that the present invention is not limited to the above exemplary embodiments, and various modification can be made without departing from the gist of the present invention. For example, the decision bit information is not limited to the form described in the above exemplary embodiments, and can be appropriately changed depending on the structure of the memory. More specifically, though the decision bit information is generated inside the memory based on the data input from the outside of the memory according to the first exemplary embodiment and is held in a second sub-array, the method of generating the decision bit may be appropriately changed. For example, the decision bit information may be directly input from the outside of the memory and may be held in the second sub-array.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor memory device comprising:
a first sub-array that holds write data input from an outside of the semiconductor memory device;
an input data recognition circuit that generates decision bit information associated with the write data, based on a combination of data items contained in the write data;
a second sub-array that holds the decision bit information;
an internal address generation circuit that generates an internal address for selectively specifying read data stored in the first sub-array, based on the decision bit information; and
an output circuit that outputs the read data selected by the internal address.

2. The semiconductor memory device according to claim 1, wherein the output circuit outputs the internal address generated so as to correspond to the read data.

3. The semiconductor memory device according to claim 1, wherein, when the combination of the data items contained in the write data held in the first sub-array is a predetermined characteristic value, the input data recognition circuit sets the decision bit information as a first logical value, and when the combination of the data items contained in the write data is a value other than the predetermined characteristic value, the input data recognition circuit sets the decision bit information as a second logical value.

4. The semiconductor memory device according to claim 1, wherein the write data and the decision bit information are held in different sub-arrays.

5. The semiconductor memory device according to claim 1, further comprising a decision bit recognition circuit that reads out the decision bit information from the second sub-array, and outputs an internal address decision signal for specifying the internal address to be generated by the internal address generation circuit, to the internal address generation circuit based on the decision bit information.

6. A data input/output method of a semiconductor memory device, comprising:
holding write data input from an outside of the semiconductor memory device;
generating decision bit information based on a combination of data items contained in the write data;
generating an internal address for selectively specifying read data, based on the decision bit information; and
outputting the read data selected by the internal address.

7. The data input/output method of a semiconductor memory device according to claim 6, wherein the read data and the internal address corresponding to the read data are output.

8. The data input/output method of a semiconductor memory device according to claim 6, wherein, when the combination of the data items contained in the write data is a predetermined characteristic value, the decision bit information is set as a first logical value, and when the combination of the data items contained in the write data is a value other than the predetermined characteristic value, the decision bit information is set as a second logical value.

9. A semiconductor memory device comprising:
a sub-array that holds write data input from an outside of the semiconductor memory device;
an output data recognition circuit that generates decision bit information associated with read data, based on a combination of data items contained in the read data stored in the sub-array;
an internal address generation circuit that generates an internal address for selectively specifying the read data, based on the decision bit information; and
an output circuit that holds the read data and outputs the read data selected by the internal address.

10. The semiconductor memory device according to claim 9, wherein the decision bit information is generated by the output data recognition circuit.

11. The semiconductor memory device according to claim 9, wherein, when the combination of the data items contained in the read data obtained when the write data held in the sub-array is read is a predetermined characteristic value, the output data recognition circuit sets the decision bit information as a first logical value, and when the combination of the data items contained in the read data is a value other than the predetermined characteristic value, the output data recognition circuit sets the decision bit information as a second logical value.

12. The semiconductor memory device according to claim 9, further comprising a decision bit recognition circuit that reads out the decision bit information from the output data recognition circuit, and outputs an internal address decision signal for specifying the internal address to be generated by the internal address generation circuit, to the internal address generation circuit based on the decision bit information.

13. A data input/output method of a semiconductor memory device, comprising:
holding write data input from an outside of the semiconductor memory device;
generating decision bit information based on a combination of data items contained in the write data output as read data;
generating an internal address for selectively specifying the read data, based on the decision bit information; and
outputting the read data selected by the internal address.

14. The data input/output method of a semiconductor memory device according to claim 13, wherein, when the combination of the data items contained in the read data is a predetermined characteristic value, the decision bit information is set as a first logical value, and when the combination of the data items contained in the read data is a value other than the predetermined characteristic value, the decision bit information is set as a second logical value.

15. A semiconductor memory device comprising:
a first sub-array that holds data input from an outside of the semiconductor memory device;
a data recognition circuit that generates decision bit information corresponding to the data, based on a combination of values contained in the data;
an internal address generation circuit that generates an internal address for selectively specifying the data stored in the first sub-array, based on the decision bit information; and
an output circuit that outputs the data selected by the internal address.

16. The semiconductor memory device according to claim 15, further comprising a second sub-array that holds the decision bit information, wherein:
the data recognition circuit generates the decision bit information based on the data written to the first sub-array; and
the second sub-array associates the decision bit information generated by the data recognition circuit with the data and stores the decision bit information associated with the data.

17. The semiconductor memory device according to claim 15, wherein the data recognition circuit generates the decision bit information based on the data read from the first sub-array.

18. A data input/output method of a semiconductor memory device, comprising:
holding data input from an outside of the semiconductor memory device;
generating decision bit information based on a combination of values contained in the data;
generating an internal address for selectively specifying the data based on the decision bit information; and
outputting the data selected by the internal address.
